(19) United States
(12) Patent Application Publication
(10) Pub. No.: US 2009/0313420 A1
(43) Pub. Date: Dec. 17, 2009

(54) Method for saving an address map in a memory device

(76) Inventors: Nimrod Wiesz, Ra'anana (IL); Sandra Almog Goldschmidt, Herzeliya (IL)

Correspondence Address: BRINKS HOFER GILSON & LIONE/SanDisk, P.O. BOX 10395, CHICAGO, IL, 60610, US

(21) Appl. No.: 12/157,845

(22) Filed: Jun. 13, 2008

(51) Int. Cl. G06F 12/16; G06F 12/02; G06F 12/08

(52) U.S. Cl. 711/103; 711/161; 711/135; 711/E12.008; 711/E12.022; 711/E12.103

(57) ABSTRACT

A method for saving an address map in a memory device is provided. In one embodiment, a logical-to-physical address map is stored in a volatile memory of a memory device. The memory device receives a command from a host device to perform an operation that is associated with a power-down sequence of the host device, such as a flush cache command. In response to receiving the command, the memory device performs the operation and saves the logical-to-physical address map in a non-volatile memory of the memory device. In this way, the command triggers both the performance of the operation and the saving of the logical-to-physical address map in the non-volatile memory of the memory device.

### BACKGROUND

Some memory devices, such as some memory cards and solid state drives, include a non-volatile memory to store data, programs, and other information and a controller. Storage locations in the non-volatile memory are logically addressed by a host device in communication with the memory device, and the controller in the memory device uses a logical-to-physical address map to convert the logical addresses supplied by the host device to corresponding physical addresses of the non-volatile memory. The logical-to-physical address map may be created upon power-on by scanning the non-volatile memory to create the map. However, this process may be time consuming and reduce performance of the memory device, especially when the non-volatile memory has a relatively-large storage capacity. Accordingly, some memory devices copy the logical-to-physical address map from the volatile memory to the non-volatile memory, so that the address map can be later retrieved and used. Some memory devices are configured to save the logical-to-physical address map in response to a specialized command from the host device. By being specialized, such command may not conform to standard command set interfaces and may require modification to the host device, which may be cumbersome, inconvenient, and expensive.

### SUMMARY

The present invention is defined by the following claims, and nothing in this section should be taken as a limitation on those claims.

By way of introduction, the embodiments described below provide a method for saving an address map in a memory device. In one embodiment, a logical-to-physical address map is stored in a volatile memory of a memory device. The memory device receives a command from a host device to perform an operation that is associated with a power-down sequence of the host device, such as a flush cache command. In response to receiving the command, the memory device performs the operation and saves the logical-to-physical address map in a non-volatile memory of the memory device. In this way, the command triggers both the performance of the operation and the saving of the logical-to-physical address map in the non-volatile memory of the memory device. Other embodiments are provided, and each of the embodiments can be used alone or in combination with one another. The embodiments will now be described with reference to the attached drawings.

### BRIEF DESCRIPTION OF THE DRAWINGS

FIG. 1 is a block diagram of an exemplary memory device and host device of an embodiment.

FIG. 2 is a flowchart illustrating a method of an embodiment for saving a logical-to-physical address map.

FIG. 3 is a flowchart illustrating a method of an embodiment for providing a logical-to-physical address map.

### DETAILED DESCRIPTION

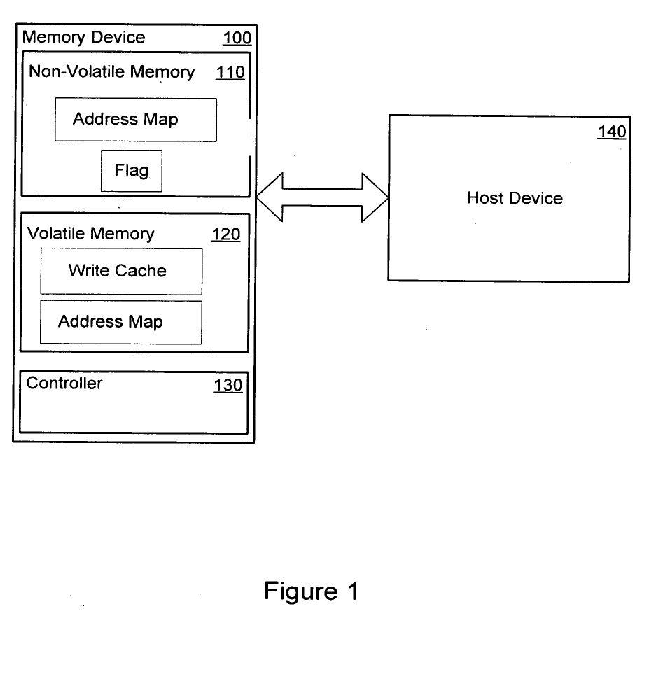

Turning now to the drawings, FIG. 1 is block diagram of an exemplary memory device 100 and host device 140 of an embodiment. As shown in FIG. 1, the memory device 100 comprises a non-volatile memory 110, a volatile memory 120, and a controller 130. It should be noted that any type of memory can be used (e.g., flash, magnetic, optical, etc. for the non-volatile memory 110 and random access memory (RAM) for the volatile memory 120). Also, the memory device 100 can take any suitable form, such as, but not limited to, a solid-state drive, a memory card, and a USB memory device. The memory device 100 can also be part of another electronic device such as, but not limited to, a cell phone or a personal digital assistant (PDA).

Storage locations in the non-volatile memory 110 are logically addressed by the host device 140, and the controller 130 in the memory device 100 converts the logical addresses supplied by the host device 140 to corresponding physical addresses of the non-volatile memory 110 using a logical-to-physical address map stored in the volatile memory 120. The logical-to-physical address map can be created by the controller 130 scanning the non-volatile memory 110 to create the map. However, as this process may be time consuming and reduce performance of the memory device 100, especially when the non-volatile memory 110 has a relatively-large storage capacity, the controller 130 can store a copy of the logical-to-physical address map in the non-volatile memory 110. This way, instead of creating the map from scratch, the controller 130 can simply retrieve the copy of the logical-to-physical address map from the non-volatile memory 110 and store it for use in the volatile memory 120.

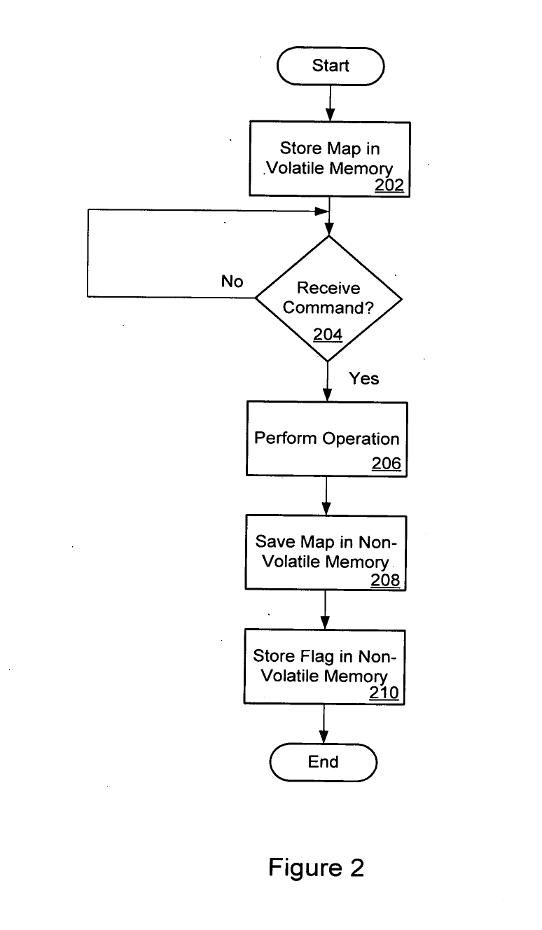

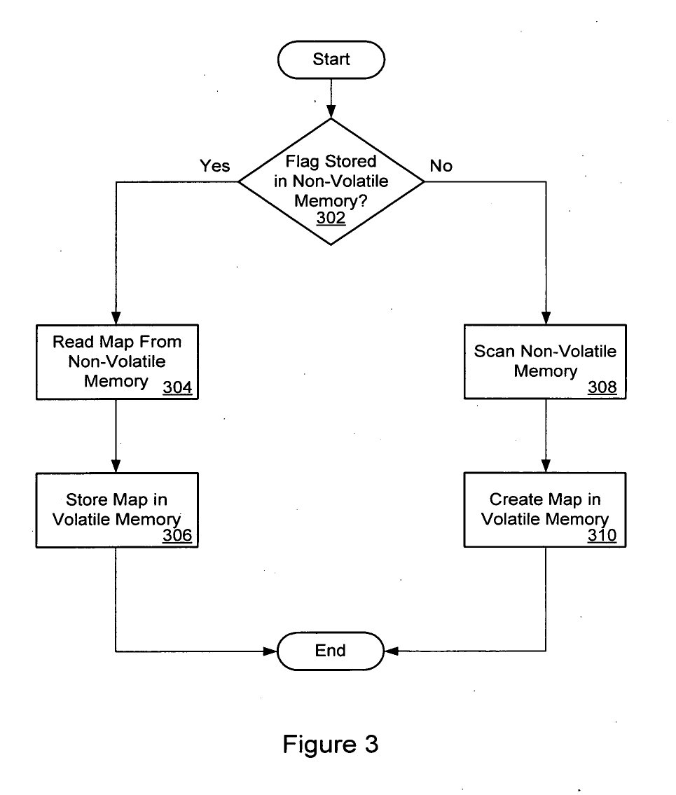

Preferably, the controller 130 saves a copy of the logical-to-physical address map before the host device 140 powers-down, as the power loss would result in the loss of the logical-to-physical address map and other data stored in the volatile memory 120. While the host device 140 can send a specialized command to cause the controller 130 to save the logical-to-physical address map in the non-volatile memory 110, a specialized command may not conform to standard command set interfaces and may require modification to the host device 140, which may be cumbersome, inconvenient, and expensive. Accordingly, in this embodiment, the command that triggers the controller 130 to save the logical-to-physical address map in the non-volatile memory 110 is preferably a standard host device 140 command (e.g., included in the Advanced Technology Attachment (ATA) or Small Computer System Interface (SCSI) command set) that is associated with a power-down sequence of the host device 140. It should be noted that a command that is “associated with a power-down sequence of the host device” can be exclusively associated with the power-down sequence (i.e., the command is only issued during a power-down sequence) or can be used in other types of operations outside of the power-down sequence, as will be discussed below. The operation of this embodiment will be described in more detail in conjunction with FIGS. 2 and 3.

FIG. 2 is a flowchart of a method of an embodiment for saving a logical-to-physical address map. The logical-to-physical address map is first stored in the volatile memory 120 for use in operation of the memory device 100 (act 202). The logical-to-physical address map can be created from scratch or can be retrieved from the non-volatile memory 110, as will be described below. In response to receiving a command from the host device 140 to perform an operation that is associated with a power-down sequence of the host device 140 (act 204), the controller 130 both performs the operation (act 206) and saves the logical-to-physical address map in the non-volatile memory 110 (act 208). In this way, the command triggers both the performance of the operation and the saving of the logical-to-physical address map in the non-volatile memory 110. Accordingly, no specialized command or modification to the host device 140 is needed, as the controller 130 merely reacts to a command normally issued by the host device 140.

As noted above, such command is preferably associated with a power-down sequence of the host device 140, as it is preferred that the logical-to-physical address map be stored before the host device 140 powers down. While such a command may be used only during the power-down sequence, the command may be used in other operations of the host devices 140. In one embodiment, one such command is the flush cache command. When the host device 140 writes data to the memory device during normal operation, the data is initially stored in a write cache in the volatile memory 120 before being stored in the non-volatile memory 110. In this way, the write cache buffers the incoming data if the non-volatile memory 110 is not ready to accept the data from the host device 140. A flush cache command causes the controller 130 to flush the write cache, storing the data therein in the non-volatile memory 110. The host device 140 can issue a flush cache command to flush the write cache in the volatile memory 120 during a power-down sequence of the host device 140 (e.g., the host device 140 flushes its internal cache by sending a write command to the memory device 100, sends a flush cache command to the memory device 100, and powers-off after the memory device 100 complete the flush cache command). However, the host device 140 can also issue a flush cache command other than during power-down, such as when the host device 140 needs to verify that critical data is securely stored.

By saving the logical-to-physical address map in the non-volatile memory 110 prior to power-down of the host device 140, the logical-to-physical address map is stored so that, upon a subsequent power-on, the stored logical-to-physical address map can be retrieved from the non-volatile memory 110 instead of scanning the non-volatile memory 110 to create a new logical-to-physical address map. To assist in this retrieval process, it is preferred that a flag be stored in the non-volatile memory 110 after the logical-to-physical address map is saved (act 210). This flag indicates that the logical-to-physical address map has been saved so that upon power-on, the non-volatile memory does not need to be scanned to create a new logical-to-physical address map. The flag can take any suitable form, such as, but not limited to, a bit, byte, or other unit of information. Storing a checksum value of the entries in the logical-to-physical address map or storing another value may also serve as the flag to indicate the logical-to-physical address map has been saved. A checksum value may also be used to confirm the validity of the logical-to-physical address map.

As shown in FIG. 3, when the memory device 100 is powered-on, the controller 130 determines if a flag is stored in the non-volatile memory 110 (act 302). A stored flag indicates that the logical-to-physical address map has been stored in the non-volatile memory 110. In such a situation, the controller 130 reads the logical-to-physical address map from the non-volatile memory 10 (act 304) and stores it in the volatile memory 120 (act 306) for further use by the controller 130 in the operation of the memory device 100. However, if the flag is not stored in the non-volatile memory 120, the controller 130 scans the non-volatile memory 110 (act 308) and creates the logical-to-physical address map for storage in the volatile memory 120 (act 310).

It is intended that the foregoing detailed description be understood as an illustration of selected forms that the invention can take and not as a definition of the invention. It is only the following claims, including all equivalents, that are intended to define the scope of this invention.

What is claimed is:

1. A method for saving a logical-to-physical address map in a non-volatile memory of a memory device, the method comprising:
storing a logical-to-physical address map in a volatile memory of a memory device;
receiving, from a host device in communication with the memory device, a command to perform an operation that is associated with a power-down sequence of the host device;
in response to receiving the command:
performing the operation; and
saving the logical-to-physical address map in a non-volatile memory of the memory device;
wherein the command triggers both the performance of the operation and the saving of the logical-to-physical address map in the non-volatile memory of the memory device.

2. The method of claim 1, wherein the command is also issued by the host device in a situation other than during a power-down sequence of the host device.

3. The method of claim 1, wherein the command comprises a flush cache command.

4. The method of claim 1, wherein the command comprises an Advanced Technology Attachment command.

5. The method of claim 1, wherein the memory device comprises a solid state drive.

6. The method of claim 1, wherein the non-volatile memory comprises flash memory.

7. The method of claim 1, wherein the volatile memory comprises random access memory.

8. The method of claim 1 further comprising, upon power-on, reading the logical-to-physical address map from the non-volatile memory and storing the logical-to-physical address map in the volatile memory.

9. The method of claim 1 further comprising:
storing a flag in the non-volatile memory after the logical-to-physical address map is saved in the non-volatile memory.

10. The method of claim 9 further comprising, upon power-on:
determining whether the flag is stored in the non-volatile memory;
if the flag is stored in the non-volatile memory, reading the logical-to-physical address map from the non-volatile memory and storing the logical-to-physical address map in the volatile memory; and
if the flag is not stored in the non-volatile memory, creating a new logical-to-physical address map.

11. A method for saving a logical-to-physical address map in a non-volatile memory of a memory device, the method comprising:
storing a logical-to-physical address map in a volatile memory of a memory device;
receiving a flush cache command to perform a flush cache operation;
in response to receiving the flush cache command:
performing the flush cache operation; and
saving the logical-to-physical address map in a non-volatile memory of the memory device;
wherein the command to perform the flush cache operation triggers both the performance of the flush cache operation and the saving of the logical-to-physical address map in the non-volatile memory of the memory device.

12. The method of claim 11, wherein the flush cache command is received from a host device in communication with the memory device.

13. The method of claim 11, wherein the memory device comprises a solid state drive.

14. The method of claim 11, wherein the non-volatile memory comprises flash memory.

15. The method of claim 11, wherein the volatile memory comprises random access memory.

16. The method of claim 11 further comprising, upon power-on, reading the logical-to-physical address map from the non-volatile memory and storing the logical-to-physical address map in the volatile memory.

17. The method of claim 11 further comprising:
storing a flag in the non-volatile memory after the logical-to-physical address map is saved in the non-volatile memory.

18. The method of claim 17 further comprising, upon power-on:
determining whether the flag is stored in the non-volatile memory;
if the flag is stored in the non-volatile memory, reading the logical-to-physical address map from the non-volatile memory and storing the logical-to-physical address map in the volatile memory; and
if the flag is not stored in the non-volatile memory, creating a new logical-to-physical address map.
